(19) United States
(12) Patent Application Publication
(10) Pub. No.: US 2011/0255556 A1
(43) Pub. Date: Oct. 20, 2011

(54) METHOD FOR TRANSPORT STREAM SYNCHRONIZING IN A MULTIPLEXER COMPRISING AN EXTERNAL CORPOCESSOR

(76) Inventor: Frederic Landais, Cesson Sevigne Cedex (FR)

(21) Appl. No.: 12/998,932

(22) PCT Filed: Dec. 17, 2009
(86) PCT No.: PCT/EP2009/067425

§ 371 Date: Jun. 17, 2011

(30) Foreign Application Priority Data
Dec. 19, 2008 (FR) 0858821

(51) Int. Cl. H04L 12/56

(52) U.S. Cl. 370/474

(57) ABSTRACT

The present invention relates to a method for synchronizing a plurality of input transport streams into an output transport stream in a multiplexing device, at least one input stream being modified by an external audio/video coprocessor before multiplexing. The external audio/video coprocessor and the multiplexing device have no common time reference. To avoid having to resynchronise the input stream coming from the external coprocessor, it is proposed according to the invention to transmit, with at least one transport packet of said input stream transmitted to the external coprocessor, an item of ‘synchronisation’ information based on the input timestamp of said transport packet at the multiplexer input. Application: production and broadcasting of television programme packages.

### FIELD OF THE INVENTION

The present invention relates to a method for synchronizing an input transport stream into an output transport stream in a multiplexing device, each transport stream comprising a plurality of transport packets. More particularly, the invention finds its application in the production and broadcasting of television programme packages.

### TECHNOLOGICAL BACKGROUND OF THE INVENTION

The production of programme packages consists, generally, in collecting programmes from various devices, typically cameras, encoders, video servers, multiplexers or network adapters, and in multiplexing them together to form packages that are then broadcast via broadcast networks such as satellite networks or cable networks. Throughout this chain, the data exchanged are generally in the form of Transport Streams (TS) as defined in the MPEG standard, each transport stream comprising a plurality of TS transport packets.

During the construction of a programme package, the transport stream of some programmes can be modified before multiplexing in order to, for example, adapt its bitrate or its coding format to that of other streams of the package or to insert an advertisement. This modification of the stream is for example carried out by an external processing device, such as an audio/video coprocessor, connected to the multiplexer. Such a system comprising a multiplexer and an external processing device is shown in FIG. 1.

In this figure, a multiplexer 11 receives a plurality of input transport streams corresponding to a plurality of programmes referenced from A to Z and delivers a plurality of output transport streams corresponding to programme packages referenced 1 to n. Each output transport stream is a multiplex of at least one part of the input transport streams. As previously indicated, some of these input transport streams are transmitted, before multiplexing, to an external processing device 10 for modification then are retransmitted to the multiplexer 11 after modification. In the example of FIG. 1, the transport streams of programmes A and C are transmitted to the processing device 10 then retransmitted, after modification, to the multiplexer 11 in modified form A+ and C+. The modified and non-modified input transport streams are then multiplexed to form the output transport streams of packages 1 to n.

In this type of system, comprising both a multiplexer and an external processing device, the synchronisation of transport packets between the input and output of the multiplexer is relatively complex to manage, particularly when the internal clock of the external processing circuit is less precise than that of the multiplexer. Moreover, the multiplexer and the external device have no common time reference which makes the synchronisation of data between the two devices complex to manage.

In fact, the system must be able to obtain a perfect synchronisation between the input and the output of the multiplexer. To do this, the multiplexer generally comprises a very precise internal clock that is particularly used to timestamp the incoming transport packets and the outgoing transport packets.

In the rest of the present description, input timestamp designates the date of a transport packet, possibly corrected if the transport packet was delayed with respect to other subsequent transport packets, at which the transport packet is received by the multiplexer and output timestamp designates the date at which it must be transmitted at the output of the multiplexer.

The input timestamp of a transport packet is determined according to the real timestamp at which the transport packet is received and a PCR (Program Clock Reference) temporal reference contained in some transport packets. PCR temporal references are transmitted at quasi-regular intervals in the transport stream, typically every 40 milliseconds. The PCR reference contained in a packet provides information on the temporal position of this packet in the transmitted transport stream. It enables the rhythm of the transmitted transport stream to be recovered and therefore to know, in a relative manner, the timestamp at which the transport packet containing this temporal reference should be received. If, for any reason, the transport packet was delayed before being received by the multiplexer or if it was transmitted in advance, the multiplexer can detect it from the PCR reference and take this into account to determine the input timestamp of the packet at the instant at which it is received by the multiplexer.

Then, the multiplexer determines the output timestamp of each transport packet from its input timestamp. The output timestamp is also equal to the sum of the input timestamp and a time corresponding to the maximum processing time of the system (maximum processing time for the audio/video processing and the multiplexing). However, if the internal clock of the external processing device is not synchronised on that of the multiplexer and is less precise, a new input timestamp and a new output timestamp must be calculated for the transport packets modified by this external device so that the jitter introduced by it does not interfere with the synchronisation of the system. The transport packets processed by the external processing circuit are therefore timestamped twice, a first time when they are received by the multiplexer and a second time after modification by the external processing circuit, which extends the processing time of the system.

### SUMMARY OF THE INVENTION

The purpose of the present invention is to propose a solution making it possible to avoid having to recalculate an input timestamp for the transport packets modified by an external processing device having an imprecise internal clock and no common time reference with the multiplexer in charge of forming the data stream.

According to the invention, the multiplexer introduces, into the transport stream transmitted to the external processing device, an item of ‘synchronisation’ information based on the input timestamp of the transport packet and recovers, after modification of the transport stream by the external processing device, this item of synchronisation information to determine the output timestamp.

For this purpose, the present invention proposes a method for synchronizing at least one transport stream referred to as input stream, into at least one transport stream, referred to as output stream, in a multiplexing device, each transport stream comprising a plurality of transport packets, said method comprising the following steps to:
receive said at least one input stream,
determine an input timestamp for each transport packet of said at least one input stream,
transmit at least one received input stream to an external processing device to modify the transport packets of said input stream, said external device and said multiplexing device having no common time reference,
receive said at least one modified input stream,
determine an output timestamp for each transport packet of said at least one input stream, and
multiplex the transport packets of said at least one input stream according to their output timestamp to generate said at least one output stream,

characterized in that, to maintain the synchronisation between the transport packets of said at least one input stream and the transport packets of said at least one output stream, an item of ‘synchronisation’ information based on the input timestamp of said at least one transport packet is transmitted, with at least one transport packet of said at least one input stream transmitted to the external processing device, the output timestamp of each transport packet of said at least one modified input stream being determined from its input timestamp and from said synchronisation information.

According to a particular embodiment, the input streams are MPEG streams and the transport streams are TS streams.

According to a particular embodiment, an item of synchronisation information is transmitted with each transport packet of the input stream or streams to be modified. The synchronisation information transmitted with the transport packet is then advantageously the input timestamp of the transport packet.

According to another embodiment, an item of synchronisation information is transmitted with at least one transport packet of each input stream to be modified, said at least one transport packet comprising a temporal reference such as an item of PCR information.

According to a particular embodiment, an item of synchronisation information is transmitted with each transport packet of the stream that comprises a PCR temporal reference.

According to a particular embodiment of the invention, the synchronisation information for a transport packet comprising a temporal reference is the difference between the input timestamp of said transport packet and said temporal reference.

In all of these embodiments, the synchronisation information transmitted with a transport packet is preferably attached to this transport packet, this synchronisation information is placed before or after this packet. As a variant, the synchronisation information is transmitted separately.

Moreover, the invention also relates to a system for multiplexing at least one transport stream, referred to as an input stream, into at least one transport stream, referred to as an output stream, each transport stream comprising a plurality of transport packets, said system is comprising a multiplexing device to multiplex said at least one input stream and a processing device connected to said multiplexing device to modify at least one input stream before multiplexing,

said multiplexing device comprises first reception means to receive said at least one input stream, first determination means to determine an input timestamp for each transport packet of said at least one input stream, transmission means to transmit at least one input stream to said processing device, second reception means to receive said at least one input stream modified by said processing device, second determination means to determine an output timestamp for each transport packet of said at least one input stream, and multiplexing means to multiplex the transport packets of said at least one input stream according to their output timestamp and generate said at least one output stream,

characterized in that, to maintain the synchronisation between the transport packets of said at least one input stream and the transport packets of said at least one output stream, the transmission means of the multiplexing device insert, in at least one transport packet of said at least one input stream transmitted to the processing device, an item of synchronisation information based on the input timestamp of said at least one transport packet, and the second determination means determine the output timestamp of at least one transport packet of said at least one input stream modified from the input timestamp of said packet and from said synchronisation information.

### BRIEF DESCRIPTION OF THE FIGURES

The invention will be better understood, and other purposes, details, characteristics and advantages will appear more clearly during the following detailed explanatory description of two currently preferred particular embodiments of the invention, with reference to the annexed diagrammatic drawings, wherein:

FIG. 1 shows a multiplexing system comprising a multiplexer and an external audio/video processing device suitable for implementing the method of the invention,

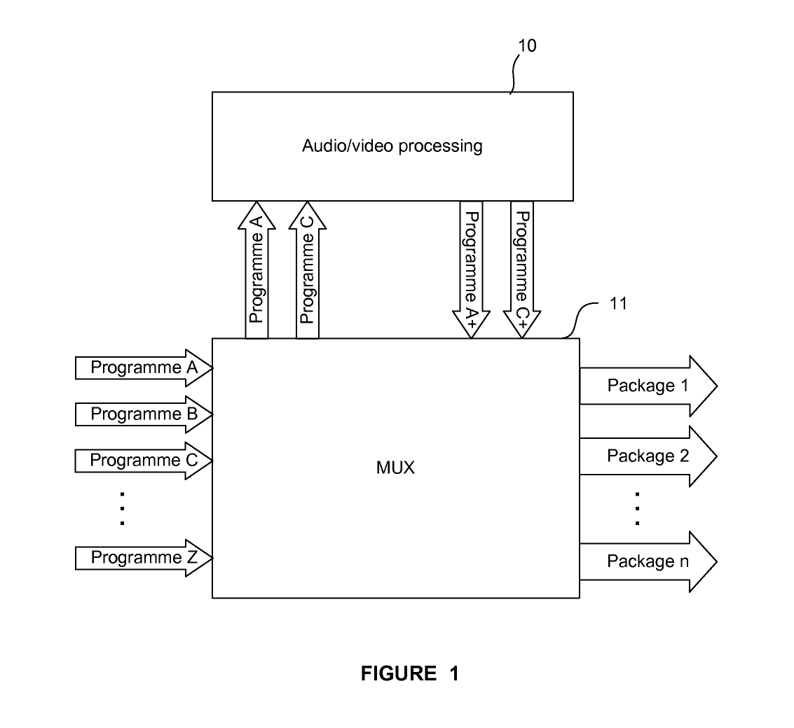

FIG. 2 shows transport streams at the input and the output of an external processing device, and

FIG. 3 shows a flow chart of the method according to the invention.

### DETAILED DESCRIPTION OF AN EMBODIMENT

According to the invention, it is attempted to make the external processing device behave like an internal component of the multiplexer having access to the extremely precise internal clock of the multiplexer. For this reason, an item of synchronisation information based on the input timestamps determined by the multiplexer is transmitted with the transport stream destined for the external processing device. After modification of the transport stream, the multiplexer recovers this synchronisation information to determine the output timestamp.

The external processing device being for example an audio/video coprocessor, in the interests of simplification, the term “coprocessor” will be used to designate the external processing device in the remainder of the description.

The invention will be described in the context of a transport stream in accordance with the MPEG standard. The transport streams are TS (Transport Stream) streams comprising TS packets, PCR (Program Clock Reference) temporal references being present at regular intervals in the TS packets of the stream.

According to the invention, when the multiplexer receives a TS packet, it determines, for this TS packet, an input timestamp, referred to as MCR_in (Multiplexer Clock Reference). The multiplexer determines this input timestamp according to the instant at which it receives the TS packet and the PCR information contained in the packet or in one of the previous TS packets.

According to a first embodiment, the multiplexer inserts this input timestamp MCR_in into the packets transmitted to the coprocessor. The communication protocol between the multiplexer and the coprocessor is then modified to enable this insertion. The size of packets transmitted to the coprocessor is for example 196 bytes, 8 bytes being reserved for the input timestamp. After modification of the packet by the coprocessor, the multiplexer recovers this input timestamp to determine the output timestamp, noted as MCR_out. The output timestamp of packets is then determined in the following manner:

MCR_out=MCR_in+Max_proc_time

where Max_proc_time designates the maximum processing time of the system of the multiplexer and of the coprocessor.

This output timestamp is calculated in the same manner for the transport packets modified by the coprocessor and for the transport packets not modified by the coprocessor.

This embodiment is not applicable when the coprocessor changes the bitrate of the transport stream.

More generally, the input and output bitrate of the coprocessor can be different. For example, when the coprocessor converts an MPEG2 transport stream into an H264 transport stream, the compression rate of the H264 format being higher than that of the MPEG2 format, the number of packets at the output of the coprocessor is then less than at the input. Conversely, when the coprocessor inserts a commercial advertisement into the transport stream, it adds packets into the stream. In this general case, there is, therefore, not necessarily any bijection between the input and the output of the coprocessor.

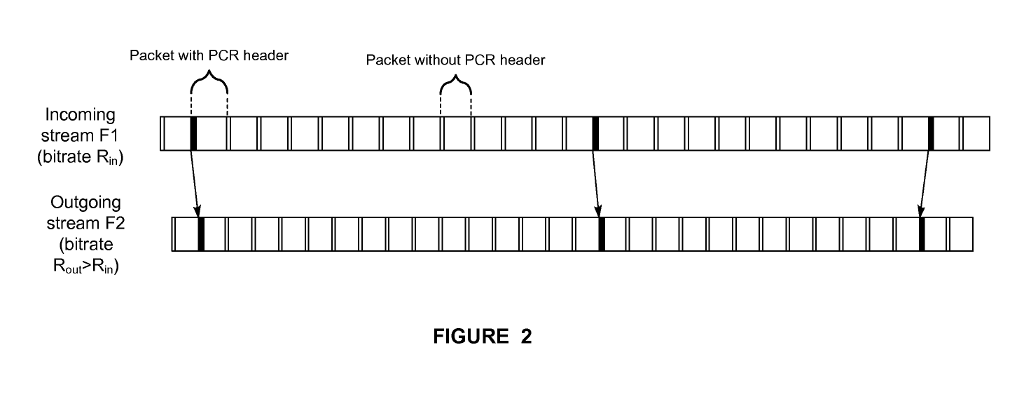

The transport streams at the input and the output of the coprocessor in the general case are shown in FIG. 2. In this figure, two transport streams are considered, an incoming stream F1 in the coprocessor having a bitrate Rᵢₙ and an outgoing stream F2 having a bitrate Rₒᵤₜ>Rᵢₙ. Each transport packet comprises a header and payload. PCR references are present at quasi-regular intervals in the two transport streams. These PCR references are contained in the header of the transport packets. The presence of such PCR references at quasi-regular intervals in the transport streams is imposed by the transmission standards. For example, the DVB (Digital Video Broadcasting) standard imposes that each transport stream contains a PCR reference at least every 40 ms. Thus, if the coprocessor deletes, in the incoming stream, a transport packet containing a PCR reference, it introduces a PCR reference in another packet of the outgoing stream so that the outgoing stream remains in accordance with the transmission standard. Moreover, given the bitrate difference between the incoming stream and the outgoing stream, the transport packets containing a PCR reference are not positioned at the same places in the incoming stream and in the outgoing stream. The coprocessor recalculates the PCR reference of packets of the outgoing stream according to their exact position in the outgoing stream. In the remainder of the description, PCR_in designates the temporal references contained in the incoming stream and PCR_out the temporal references contained in the outgoing stream.

A second embodiment of the method of the invention is proposed hereafter to take account of the general case (case where the input and output bitrates of the coprocessor are different).

According to this embodiment, an item of synchronisation information, noted as MCR_offset is transmitted in the TS packets containing a PCR reference (=PCR_in) transmitted to the coprocessor, corresponding to the difference between the input timestamping MCR_in and the reference PCR_in of the TS packet considered: MCR_offset=MCR_in−PCR_in.

Once the TS packet is modified and retransmitted to the multiplexer, the output timestamp MCR_out is determined in the following manner for the packets containing a PCR reference (=PCR_out):

MCR_out=PCR_out+MCR_offset+Max_proc_time

For the packets of the outgoing stream not containing a PCR reference (=PCR_out), an estimation of PCR_out of this packet is calculated based on the last PCR_out received, the number of packets received since the last packet containing a PCR_out and the output bitrate of the coprocessor. This output bitrate is a configuration parameter of the coprocessor. It can be transmitted to the multiplexer with the synchronisation information MCR_offset or the multiplexer calculates it by counting the number of packets between two transport packets containing a PCR reference.

The output timestamp for the packets not comprising a PCR reference (=PCR_out) is determined in the following manner:

$$MCR\_out ( n , k ) = PCR\_out ( n , k ) + MCR\_offset ( n ) + Max\_proc \_time$$

$$with$$

$$PCR\_out ( n , k ) = PCR\_out ( n , 0 ) + \frac{k * 188 * 8 * {27.10}^{6}}{Bitrate\_segment ( n )}$$

$$and$$

$$Bitrate\_segment ( n ) = \frac{Nb\_total \_packets ( n ) * 188 * 8 * {27.10}^{6}}{PCR\_out ( n , 0 ) - PCR\_out ( n + 1 , 0 )} .$$

where
n designates a segment of TS packets starting with a packet containing a PCR reference and ending at the next packet containing a PCR reference without including it,
k is the index of a packet of the segment n,
MCR_out(n,k) designates the output timestamp of the k^{th} packet of the segment n,
PCR_out(n,k) designates the estimated PCR_out of the k^{th} packet of the segment n,
MCR_offset(n) designates the MCR_offset transmitted in the first packet of the segment n,
Bitrate_Segment (n) is the value of the output bitrate of the segment n, which value is supplied by the coprocessor to the multiplexer,
Nb_total_packets(n) is the total number of packets of the segment n,
188*8 is the number of bits in a packet, and
27.10⁶ is the frequency of the internal clock of the multiplexer (27 MHz).

In this embodiment, the synchronisation information MCR_offset being recalculated for each new packet comprising a PCR_in reference, this synchronisation information can be advantageously used by the coprocessor to resynchronise its internal clock or calculate its drift.

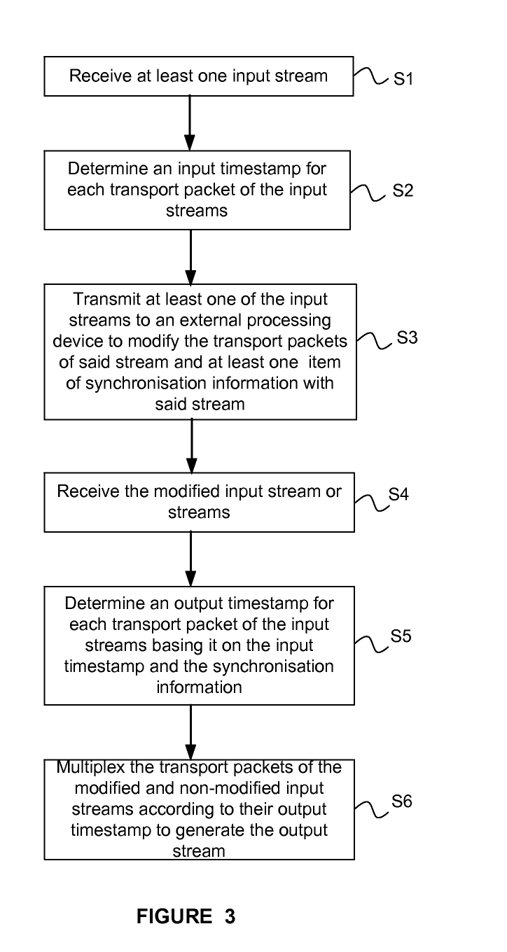

The steps of the method of the invention are summarized in FIG. 3.

According to a reference step S1, the multiplexer receives the TS packets of a plurality of input streams. It determines an input timestamp MCR_in for each TS packet received (step S2). The multiplexer then transmits at least one of the input streams received to the coprocessor to modify it and transmits, with at least one of the packets transmitted to the coprocessor, an item of ‘synchronisation’ information based on the input timestamp of said transport packet (step S3). In the first embodiment described previously, the transmitted synchronisation information is the input timestamp MCR_in of the packet In the second embodiment, the synchronisation information is transmitted only in the packets comprising a PCR reference (=PCR_in) and this synchronisation information MCR_offset is the difference between the input timestamp MCR_in of the packet and the PCR_in reference contained in the packet. If the internal clock of the multiplexer is very precise at 27 MHz and has no drift, it is also possible to transmit the synchronisation information MCR_offset only once. According to a step S4, the multiplexer receives the input streams modified by the coprocessor. It then determines an output timestamp for each input stream packet modified or not (step S5). If the packet has not been modified by the coprocessor, its output timestamp MCR_out is equal to MCR_in+Max_proc_time. If the packet has been modified by the coprocessor and represents the k^{th} packet of segment n, its output timestamp MCR_out(n,k) is equal to PCR_out(n,k)+MCR_offset(n)+Max_proc_time as defined previously. Finally, according to a step S6, the input streams are then multiplexed so as to generate the output stream, the TS packets being placed in the output stream according to their output timestamp.

The invention applies more particularly when the coprocessor is a circuit based on a PC x86 architecture which is known for the poor quality of its internal clock.

Although the invention has been described in relation to different particular embodiments, it is obvious that it is in no way restricted and that it comprises all the technical equivalents of the means described together with their combinations if the latter fall within the scope of the invention.

1. Method for synchronizing at least one transport stream referred to as input stream, into at least one transport stream, referred to as output stream, in a multiplexing device, each transport stream comprising a plurality of transport packets, said method comprising the following steps to:
receive said at least one input stream,
determine an input timestamp for each transport packet of said at least one input stream,
transmit at least one received input stream to an external processing device to modify the transport packets of said input stream, said external device and said multiplexing device having no common time reference,
receive said at least one modified input stream,
determine an output timestamp or each transport packet of said at least one input stream, and
multiplex the transport packets of said at least one input stream according to their output timestamp to generate said at least one output stream,
wherein, to maintain the synchronisation between the transport packets of said at least one input stream and the transport packets of said at least one output stream, an item of ‘synchronisation’ information based on the input timestamp of said at least one transport packet is transmitted, with at least one transport packet of said at least one input stream transmitted to the external processing device, the output timestamp of each transport packet of said at least one modified input stream being determined from its input timestamp and from said synchronisation information.

2. Method according to claim 1, wherein said at least one input stream is an MPEG stream.

3. Method according to claim 1, wherein an item of synchronization information is transmitted with each transport packet of said at least one input stream to be modified.

4. Method according to claim 3, wherein said synchronization information transmitted with a transport packet is the input timestamp of the transport packet.

5. Method according to claim 2, wherein an item of synchronization information is transmitted with at least one transport packet of said at least one input stream to be modified, said at least one transport packet comprising a temporal reference.

6. Method according to claim 5, wherein an item of synchronization information is transmitted with each transport packet comprising a temporal reference.

7. Method according to claim 5, wherein the synchronization information for a transport packet comprising a temporal reference is the difference between the input timestamp of said transport packet and said temporal reference.

8. Method according to claim 1, wherein said synchronization information is attached to transport packets of said at least one input stream transmitted to the external processing device.

9. System for synchronizing at least one transport stream, referred to as an input stream, into at least one transport stream, referred to as an output stream, each transport stream comprising a plurality of transport packets, said system comprising a multiplexing device to multiplex said at least one input stream and a processing device connected to said multiplexing device to modify at least one input stream before multiplexing, said multiplexing device and said processing device having no common time reference,
said multiplexing device comprises first reception means to receive said at least one input stream, first determination means to determine an input timestamp for each transport packet of said at least one input stream, transmission means to transmit at least one input stream to said processing device, second reception means to receive said at least one input stream modified by said processing device, second determination means to determine an output timestamp for each transport packet of said at least one input stream, and multiplexing means to multiplex the transport packets of said at least one input stream according to their output timestamp and generate said at least one output stream,
wherein, to maintain the synchronisation between the transport packets of said at least one input stream and the transport packets of said at least one output stream, the transmission means of the multiplexing device insert, in at least one transport packet of said at least one input stream transmitted to the processing device, an item of synchronisation information based on the input timestamp of said at least one transport packet, and the second determination means determine the output timestamp of at least one transport packet of said at least one input stream modified from the input timestamp of said packet and from said synchronisation information.
